(19) United States
(12) Patent Application Publication
(10) Pub. No.: US 2015/0369991 A1
(43) Pub. Date: Dec. 24, 2015

(54) LIGHT DIFFUSING FIBER LIGHTING DEVICE HAVING A SINGLE LENS

(71) Applicant: CORNING INCORPORATED, CORNING, NY (US)

(72) Inventors: Anthony Sebastian Bauco, Horseheads, NY (US); Vikram Bhatia, Painted Post, NY (US); Stephan Lvovich Logunov, Corning, NY (US)

(21) Appl. No.: 14/723,791

(22) Filed: May 28, 2015

Related U.S. Application Data
(60) Provisional application No. 62/015,735, filed on Jun. 23, 2014.

(51) Int. Cl. F21V 8/00; G02B 6/46; G02B 5/32; G02B 6/42; G02B 6/028

(52) U.S. Cl. CPC G02B 6/0006; G02B 6/0008; G02B 6/4206; G02B 6/4239; G02B 6/0288; G02B 5/32; G02B 6/46

(57) ABSTRACT

A lighting device is provided that includes a light source package including a diode disposed in a first housing having a first opening, the diode emitting light at an emission point within the first housing. The lighting device also has a lens disposed on the first housing proximate the first opening and optically aligned with the emission point and a second housing substantially enclosing the first housing and the lens, the second housing having a second opening. The lighting device also includes an optical fiber extending through the second opening in the second housing and having a terminal end optically aligned with the lens and diode. The lens is disposed between the terminal end of the fiber and the diode, and the terminal end of the fiber is within a distance of less than 2.5 millimeters from the emission point, and the fiber emits light via a light diffusing fiber.

### CROSS-REFERENCE TO RELATED APPLICATION

This application claims benefit of U.S. Provisional Application No. 62/015,735, filed Jun. 23, 2014, entitled “LIGHT DIFFUSING FIBER LIGHTING DEVICE HAVING A SINGLE LENS.” The aforementioned related application is hereby incorporated by reference.

### BACKGROUND

This disclosure pertains to a lighting device employing a light diffusing fiber, and more particularly relates to a light source package having a diode optically coupled to a fiber that emits light by way of a light diffusing fiber.

Light diffusing fibers (LDFs) can be used in various applications as light illuminators for accent lighting, indicator lighting and other applications. For compact applications, such as in consumer electronics, a light source in the form of a laser source package may be used. Typically, a plurality of optical lenses is disposed between the laser source package and the light diffusing fiber which increases the size of the device. In addition, it can be expensive to efficiently couple laser light from the laser diode to the fiber with a plurality of optical lenses. It is therefore desirable to provide for a lighting device that illuminates a light diffusing fiber with a light source package that is compact and economical to produce.

### SUMMARY

In accordance with one embodiment, a lighting device is provided. The lighting devices includes a light source package comprising a diode disposed in a first housing having a first opening, the diode emitting light at an emission point within the first housing. The lighting device also includes a lens disposed on the first housing proximate the first opening and optically aligned with the emission point and a second housing substantially enclosing the first housing and the lens, the second housing having a second opening. An optical fiber extends through the second opening in the second housing and has a terminal end optically aligned with the lens and diode, wherein the lens is disposed between the terminal end of the fiber and the diode and the terminal end of the fiber is within a distance of less than 2.5 millimeters from the emission point, and wherein the fiber emits light via a light diffusing fiber.

In accordance with another embodiment, a method of manufacturing a lighting device is provided. The method includes the step of providing a light source package comprising a diode disposed in a first housing, wherein the diode emits light at an emission point within the first housing. The method also includes the steps of forming a first opening in the first housing, disposing a lens within the first opening of the first housing, encapsulating the first housing and lens within a second housing having a second opening therein, and disposing an optical fiber extending into the second opening in the second housing and having a terminal end optically aligned with the diode. The lens is disposed between the terminal end of the fiber and the diode and the terminal end of the fiber is within a distance of less than 2.5 millimeters from the emission point, and the fiber emits light to a light diffusing fiber. The method further includes the step of fixedly connecting the fiber relative to the second housing in an optically aligned position such that light is transmitted from the emission point to the light diffusing fiber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an exploded perspective sectional view of a lighting device, according to one embodiment;

FIG. 1A is a diagrammatic cross-sectional view taken through line IA-IA of the light diffusing fiber shown in FIG. 1;

FIG. 2 is a cross-sectional side view of the lighting device of FIG. 1 having the laser source package assembled to the ferrule and the light diffusing fiber;

FIG. 3 is a cross-sectional side view of a lighting device further having ferrule connectors coupling the fiber to the laser source package, according to a second embodiment; and

FIG. 4 is a cross-sectional side view of a lighting device having the light diffusing fiber directly coupled to the laser source package, according to a third embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

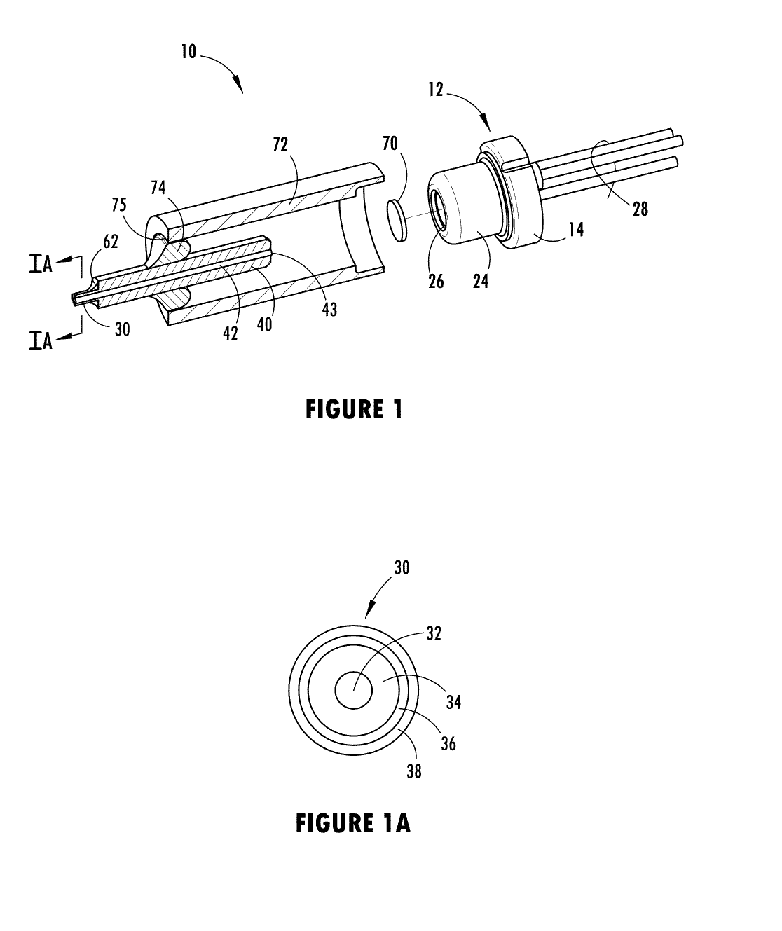

Referring to FIGS. 1-4, a lighting device 10 is illustrated for providing light illumination generated by a light source shown generally as a laser source package and output by a light diffusing fiber (LDF), according to various embodiments. The lighting device 10 includes a light source package 12 having a diode 20 disposed in a first housing 24. In the disclosed embodiments, the light source package 12 is a laser source package having a laser diode 20 mounted within a cylindrical first housing 24. The laser diode 20 emits visible light at an emission point within the first housing 24. The lighting device 10 also includes a lens disposed on the first housing proximate the first opening and optically aligned with the emission point. In a preferred embodiment, a single lens only is employed by the lighting device. The lighting device 10 also includes a second housing 72 substantially enclosing the first housing 24 and the lens 70. The second housing 72 has a second opening 75. The lighting device 10 further includes a fiber 42 or 30 extending through the second opening 75 in the second housing 72 and having a terminal end 43 or 33 optically aligned with the lens 70 and diode 20. The lens 70 is disposed between the terminal end 43 or 33 of the fiber 42 or 30 and the diode 20 and the terminal end 43 or 33 of the fiber 42 or 30 is within a distance of less than 2.5 millimeters from the emission point 22. The fiber 42 or 30 emits light via a light diffusing fiber 30. According to a more preferred embodiment, the terminal end 43 or 33 of the fiber 42 or 30 may be optically aligned with the laser diode 20 to within a distance in the range of 0.8 millimeter to 2.5 millimeters from the emission point 22. The terminal end of the fiber 42 or 30 may be less than 1.6 millimeters from the emission point 22, according to a further embodiment.

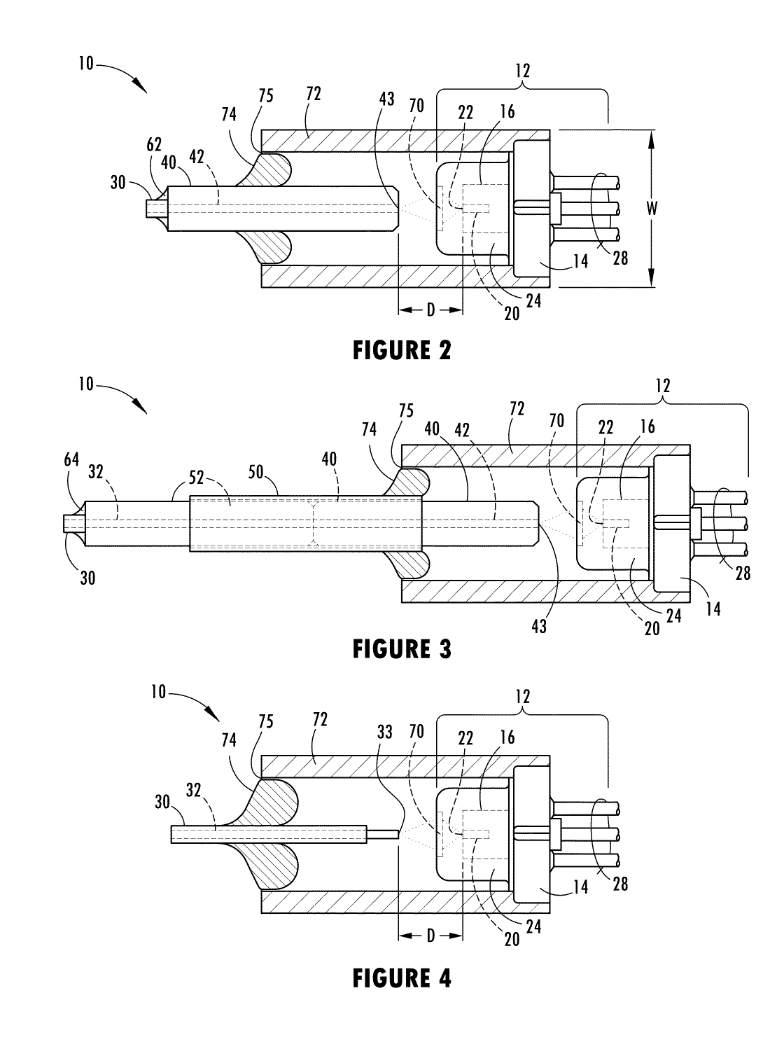

The optical fiber transmits and emits light via a light diffusing fiber 30. In one embodiment shown in FIGS. 1 and 2, a ferrule 40 extends into the second opening 75 and connects to the second housing 72, and fiber 42 is disposed in the ferrule 40. In this embodiment, the fiber 42 may be a delivery fiber that is optically coupled to a light diffusing fiber 30. The ferrule 40 may be sealed to the second housing 72. A low index adhesive 74 may be disposed between the ferrule 40 and the second housing 42 to seal the second opening 75 closed. Alternatively, or in addition, the ferrule 40 may be metal that is welded or bonded to the second housing to form a hermetic seal with the second housing 72. It should be appreciated that one or more delivery fibers may be optically coupled between the diode 20 and the light diffusing fiber 30 such that light generated by diode 20 is transmitted to the light diffusing fiber 30. The delivery fiber 42 may be disposed within a first ferrule 40, which in turn is connected to the housing 24. As seen in the embodiment of FIG. 3, first ferrule 40 may connect to a second ferrule 52 or other connector which is coupled to fiber 30, wherein the ferrules 40 and 52 are connected together in an aligned light coupling position by a sleeve 50. According to a further embodiment, a light diffusing fiber 30 may extend into the second opening 75 of second housing 72 and have a terminal end 33 optically aligned with the lens 70, absent the ferrule, as shown in FIG. 4.

The lighting device advantageously employs a single lens 70 located between the laser diode 20 and the terminal end 43 or 33 of fiber 42 or 30. As used herein, the term “lens” is broadly understood to include optical structures suitable for redirecting (e.g., focusing, concentrating, diverging, collimating and the like) electromagnetic radiation. The lens 70 receives electromagnetic energy in the form of light emitted by the diode 20 and focuses the light onto the terminal end 43 or 33 of fiber 42 or 30.

Referring now to FIGS. 1-3, the lighting device 10 is illustrated having a light diffusing fiber 30 coupled to a delivery fiber 42 and ferrule 40 which in turn is physically connected to second housing 72 and optically aligned and coupled to a light source package 12, according to a first embodiment. The light source package 12 may include a laser source package in the form of a TO can package. A commercially available TO can package may be modified and connected to second housing 72 which, in turn, supports the ferrule 40 and fiber 42 that is optically coupled to the light diffusing fiber 30 to achieve the lighting device 10 as described herein. The light source package 12 is generally illustrated and described herein as a TO can package having a base 14, and a plurality of input pins 28. The light source package 12 also includes a first housing 24 connected to the base 14. The first housing 24 may include a cylindrical metal can, according to one embodiment, which may be laser welded or otherwise connected onto the base 14 to provide a hermetic seal between the base 14 and the first housing 24. Disposed within the sealed first housing 24 is a diode 20, shown and described herein as a laser diode according to one embodiment that may be assembled onto a supporting substrate 16 which, in turn, is connected to the base 14. The laser diode 20 receives electrical power via the input pins 28 and generates a laser light emission at an emission point 22 within the first housing 24. The laser diode 20 may generate a colored light such as red, blue or green light. The base 14 may be made of a thermally conductive material, such as aluminum, to dissipate thermal energy from the diode 20 to the outside ambient environment. While a laser source package 12 having a laser diode 20 is shown and described herein according to one embodiment, it should be appreciated that the light source package 12 may be configured with other light sources such as an LED package employing a light emitting diode.

The laser source package 12 preferably has a compact size with height and length dimensions sufficiently small to enable use in small devices or applications such as consumer electronics (e.g., cell phone). The light source package 12 may include a commercially available TO can package which is typically available with the further addition of a glass window aligned with the light outlet. The commercially available TO can package may be used with a copper housing and multiple optic lenses which generally adds increased length and height to the overall package. Examples of a TO can package include commercially available 3.3 mm and a 3.8 mm TO can packages. When using a commercially available TO can package, the glass window (not shown) may be removed and not employed, and the second housing 72 which is connected to a ferrule 40 containing the fiber 42 may be attached to the first housing 24 and the ferrule 40, and the fiber 42 optically aligned with the lens 70 and laser diode 20 without the need for additional optical lenses to thereby provide an efficient optical coupling in a compact and inexpensive lighting device. The light source package 12 may have a width W of less than 4.0 millimeters, and more preferably the width W is 3.8 millimeters or less. The delivery fiber 42 and light diffusing fiber 30 may be of any suitable length to provide sufficient illumination for a given application.

The light source package 12 may be configured to include a first opening 26 in the front end of first housing 24 sufficient to enable the insertion of the lens 70 into the opening 26 within first housing 24 and into an optically aligned position with the emission point 22 of laser diode 20. According to one embodiment, the first opening 26 is circular and is sized having a diameter the same as or slightly greater than the diameter of the circular lens 70 to allow insertion of the lens 70 into first opening 26. First opening 26 ma be formed by drilling a hole into the end wall of the first housing 24 or may otherwise be configured by punching, molding, etc. In a TO can package, the first opening 26 may be the opening at the light outlet once the glass window is removed.

The outer peripheral edge of the lens 70 may receive a metal coating using metallization with a sputter coating process applied to the outer edge surface. The metallized coating may then be welded or otherwise adhered to the first housing 24 within the walls defining the first opening 26. The metallized coating may include silver which provides a low absorption at the glass/metal interface in the visible spectrum. The metalized outer surface of the lens 70, when welded or bonded to the metal first housing 24, provides a hermetic seal between the lens 70 and first housing 24. Alternatively, the lens 70 may be adhered to first housing 24 within opening 26 using an adhesive. In a further embodiment, the lens 70 may be adhered directly onto an existing window in opening 26 or onto a surface of the housing such that lens 70 extends across the window. The lens 70 is optically aligned on an optical axis with the diode 20.

A second housing 72 is further shown connected to the laser source package 12. The second housing 72 is shown as a cylindrical body which may include metal, such as copper, or a ceramic or other material connected to the base 14 of light source package 12. In one embodiment, the second housing 72 is made of copper and is welded to the base 14 of light source package 12 to form a hermetic seal. The second housing 72 substantially encloses the first housing 24 and the lens 70. The second housing 72 has a second opening 75 at the end opposite to the end connected to light source package 12. A ferrule 40 having a delivery fiber 42 interposed between the light diffusing fiber 30 and lens 70 is further illustrated. The second opening 75 in second housing 72 is formed with a diameter sufficient to receive the ferrule 40. The ferrule 40 may include a cylindrical metal housing that fits within second opening 75 of second housing 72 and may be connected to second housing 72 to form a sealed closure. In one embodiment, the ferrule 40 may be positioned and retained within the second opening 75 via a low index adhesive 74. In addition to or in lieu of the adhesive, the ferrule 40 may be metal and may extend into the second opening 75 and may be welded to second housing 72 to form a hermetic seal between the ferrule 40 and the second housing 72. It should be appreciated that the ferrule 40 may be made of metal, such as stainless steel, copper or other materials, such as ceramic or glass, according to other embodiments, and may otherwise be connected and sealed to the second housing 72.

Disposed within the ferrule 40 is a fiber 42 shown and described herein as a delivery fiber, according to one embodiment. The fiber 42 may be a light diffusing fiber, according to another embodiment. In a further embodiment, a graded index (GRIN) lens may be used as lens 70 with or without a ferrule. A GRIN lens could be disposed within the ferrule 40 in place of the delivery fiber 42 to serve as the lens. The delivery fiber 42 may include a core and cladding that has a terminal end 43 optically aligned on an optical axis with the diode 20 to within a distance D of less than 2.5 millimeter from the emission point 22, according to one embodiment. According to another embodiment, the distance D between the emission point 22 and the terminal end 43 of fiber 40 is less than 1.6 millimeters. In this embodiment, it should be appreciated that there is only a single optical lens disposed between the emission point 22 and the terminal end 43 of fiber 42.

At the opposite end of the ferrule 40 is a light diffusing fiber 30 which is shown optically coupled to the delivery fiber 42. The coupling between the light diffusing fiber 30 and light delivery fiber 42 may be achieved by aligning the fibers 30 and 42 along an optical axis and optically coupling the fibers 30 and 40 relative to one another. The optical coupling may include a butt coupling. A low index adhesive 62 may further adhere the light diffusing fiber 30 to one end of the end of the delivery fiber 42 and ferrule 40 to hold the fibers 30 and 42 together.

According to one embodiment, the fiber 42 may be formed within the ferrule 40 and the light diffusing fiber 30 may be assembled with the ferrule 40 attached thereto. The ferrule 40 may be inserted within second opening 75 of second housing 72 so as to optically align the fiber 42 with lens 70 and diode 20. The ferrule 40 may then be welded or otherwise adhered to the second housing 24 within the second opening 75. For a ceramic or other non-metal ferrule, the ferrule 42 may be metallized prior to welding so as to attach hermetically to the second housing 75. Alternatively, the ferrule 40 and fiber 42 may be hermetically connected to the second housing 75 and aligned to provide optimum light coupling between the diode 20 and the terminal end 43 of fiber 42 through lens 70. The light diffusing fiber 30 may be coupled to the delivery fiber 42 at the opposite end of ferrule 40 and adhered thereto with the low index adhesive 62.

The fiber disposed in the ferrule 40 and optically aligned with lens 70 may be a delivery fiber or a light diffusing fiber. For a fiber having a diameter of 105 micrometers and an NA of 0.17, a lighted coupling efficiency of sixty to seventy percent (60-70%) may be realized. If the fiber is a double clad fiber, with the inner glass clad having an NA of 0.53 relative to an outer polymer clad, the light coupling efficiency may be approximately ninety to ninety-five percent (90-95%). The laser diode 20 may be a spatially single mode laser diode having a beam waist of less than 10 micrometers and a NA of less than 0.5 which may be used to illuminate a multimoded light diffusing fiber having a diameter in the range of 105 to 200 micrometers and NA in the range of 0.17 to 0.53, according to one embodiment. The multimode fiber may be multimoded at a wavelength of one or both of 850 nanometers and 1,550 nanometers. Given a distance of approximately 850 micrometers between the fiber facet and the laser diode emission point 22, the light coupling efficiency may be limited in an attempt to achieve a compact lighting device. It should be appreciated that there is only a single optical lens 70 disposed between the emission point 22 and the terminal end 43 of the fiber 42.

Once the ferrule 40 and fiber 42 is disposed within second opening 75 of second housing 72 and aligned with the lens 70 and laser diode 20, the ferrule 40 may be welded or otherwise fixedly connected to second housing 72. This may include a low index adhesive 74 applied to the ferrule 40 and second housing 72 to cover and adhere the outer surface of the ferrule 72 to the second housing 72. The lighting device 10 may then be assembled into a device such as a consumer electronics device or employed in another application to provide a compact and inexpensive lighting device. It should be appreciated that the light diffusing fiber 30 may have various shapes and sizes to accommodate dimensions of the device and lighting application.

In the various disclosed embodiments, the lighting device 10 includes a light diffusing fiber 30 operatively coupled to the diode 20 to receive the light generated by the diode 20 and disperses the light for a lighting application. The light diffusing fiber 30 is a high scatter light transmission fiber that receives the light generated by diode 20 and scatters and outputs the light through the sides of the fiber. The high scatter light transmission achieved with the light diffusing fiber 30 has a light attenuation of 0.5 dB/meter or greater, according to one embodiment.

The light diffusing fiber 30 may be configured as a single light diffusing fiber. The light diffusing fiber 30 may be a multimode fiber (e.g., capable of transmitting a plurality of modes at 850 or 1550 nanometers) having a diameter, for example, in the range of 105 to 200 micrometers and may be flexible, thus allowing ease in installation to the housing 24. In one embodiment, the light diffusing fiber 30 has a diameter of 1,000 microns or less, and more particularly of about 250 microns or less. In other embodiments, the light diffusing fiber 30 may be more rigid and have a diameter greater than 1,000 microns.

One embodiment of a light diffusing fiber 30 is illustrated having a typical cross-sectional structure as shown in FIG. 1A. The light diffusing fiber 30 may include the formation of random air lines or voids in one of the core and cladding of a silica fiber. Examples of techniques for designing and forming such light diffusing fibers may be found, for example, in U.S. Pat. Nos. 7,450,806; 7,930,904; and 7,505,660, and U.S. Pat. Application Publication No. 2011/0305035, which are hereby incorporated by reference in their entirety. The light diffusing fiber 30 has a SiO₂ glass core 32 which may include a Ge-doped or F-doped core. An SiO₂ cladding layer 34 having air lines for scattering light is shown surrounding the core 32. The cladding layer 34 may be formed to include air lines or voids to scatter the light and direct the light through the side walls. It should be appreciated that the random air lines may be disposed in the core 32 or in the cladding 34 or in both, according to various embodiments. It should be appreciated that high scattering light losses are generally preferred in the light diffusing fiber 30. A low index polymer primary protective layer 36 generally surrounds the cladding layer 34. Additionally, an outer secondary layer 38 may be disposed on the primary protective layer 36. Primary protective layer 36 may be soft and liquidy, while secondary layer 38 may be harder.

Scattering loss of the light diffusing fiber 30 may be controlled throughout steps of fiber manufacture and processing. During the air line formation process, the formation of a greater number of bubbles will generally create a larger amount of light scatter, and during the draw process the scattering can be controlled by using high or low tension to create higher or lower light loss, respectively. To maximize loss of light, a polymeric cladding may be desirably removed as well, over at least a portion of the light diffusing fiber 30 length if not all. Uniform angular loss in both the direction of light propagation, as well as in the reverse direction can be made to occur by coating the light diffusing fiber 30 with inks that contain scattering pigments or molecules, such as TiO₂. The high scattering light diffusing fiber 30 may have a modified cladding to promote scattering and uniformity. Intentionally introduced surface defects on the light diffusing fiber 30 or core or cladding may also be added to increase light output, if desired.

The light diffusing fiber 30 may have a region or area with a large number (greater than 50) of gas filled voids or other nano-sized structures, e.g., more than 50, more than 100, or more than 200 voids in the cross section of the fiber. The gas filled voids may contain, for example, SO₂, Kr, Ar, CO₂, N₂, O₂ or mixture thereof. The cross-sectional size (e.g., diameter) of the nano-size structures (e.g., voids) may vary from 10 nanometers to 1 micrometer (for example, 15 nanometers to 500 nanometers), and the length may vary depending on the diameter of the air lines.

While the light diffusing fiber 30 is shown and described herein having air lines, it should be appreciated that other light scattering features may be employed. For example, high index materials such as GeO₂, TiO₂, ZrO₂, ZnO, and others may be employed to provide high scatter light transmission.

The lighting device 10 includes a low scatter light transmission fiber, i.e., a low loss optical fiber, referred to as light delivery fiber 42, coupled between the lens 70 and the light diffusing fiber 30 shown in the embodiments of FIGS. 1 and 3. According to one embodiment, the delivery fiber 42 may include an optical fiber designed to transmit light with low signal loss. The low scatter light transmission achieved with the delivery fiber 42 has a light attenuation of less than 0.5 dB/meter. The delivery fiber 42 may be coupled to the light diffusing fiber 30 by way of an aligned optical coupling. It should be appreciated that the low scatter light transmission or delivery fiber 42 may be operatively coupled to the light diffusing fiber 30 using various optical connections including splices, butt couplings, optical couplings, and other light transmission couplings.

Referring to FIG. 3, the lighting device 10 is illustrated having a first ferrule 40 connected to second housing 72 which, in turn, is connected to the light source package 12, and the first ferrule 40 is further aligned and connected to a second ferrule 52. The first ferrule 40 may have a delivery fiber 42 optically aligned with respect to the diode 20 as discussed above with respect to the first embodiment shown in of FIG. 1. In addition, the first ferrule 40 is removably connected with the second ferrule 52 which, in turn, is coupled to the light diffusing fiber 30 via an optical coupling and the low index adhesive 64. The first and second ferrules 40 and 52 are configured to align to allow optical fibers within each of the first and second ferrules 40 and 52 to efficiently couple light therebetween. In addition, an outer connector sleeve 50 surrounds the first and second ferrules 40 and 52 to maintain the first and second ferrules 40 and 52 in a fixed and aligned position. It should be appreciated that the sleeve 50 may include a tube having a longitudinal opening that allows the tube to flex and compress over the ferrules 40 and 52 to frictionally engage the ferrules 40 and 52. The sleeve 50 may have threads or other engagement mechanism for maintaining the position of the first and second ferrules 40 and 52 relative to one another. In lieu of the second ferrule 52, another connecting device may be employed to couple the light diffusing fiber 30 to the first ferrule 40. For example, telecommunications connectors such as ST, FC, or SMA connectors may be employed. In either embodiment, the second ferrule 52 containing the light diffusing fiber may be slid into a mechanical mating mechanism, such as a mating sleeve or other receptacle which contains the first ferrule 40 and is integrated with the second housing 72. While first and second ferrules or connectors are shown in this embodiment, it should be appreciated that additional connectors or ferrules may be coupled between the light source package 12 and the light diffusing fiber 30, and that two or more delivery fibers may be used.

Referring to FIG. 4, the lighting device 10 is illustrated having the light diffusing fiber 30 extending into the second opening 75 of the second housing 72 and connected thereto, without the use of one or more ferrules as described in connection with the first and second embodiments. In this embodiment, the light diffusing fiber 30 is adhered to the second housing 72 via a low index adhesive 74 and held in position relative to the second housing 72. The light diffusing fiber 30 is optically aligned with the lens 70 such that light generated by diode 20 is emitted at emission point 22 through lens 70 onto the terminal end 33 of light diffusing fiber 30. In this embodiment, the terminal end 33 of light diffusing fiber 30 is within a distance D of less than 2.5 millimeters from the emission point 22. It should be appreciated that other structural support for maintaining the alignment and fixed relationship of the light diffusing fiber 30 to the second housing 72 may be employed.

The lens 70 may include a biconvex lens, a planoconvex lens, a Fresnel lens, a GRIN lens or a volume holographic lens, according to various embodiments. A volume holographic lens may be a pre-written lens having gratings that were prefabricated, and the ferrule with the delivery fiber 42 disposed thereon or light diffusing fiber 30 may be aligned with the lens 70 in the X, Y and Z directions. The holographic lens may alternatively be written to form the gratings after the lens 70 has been installed onto the light source package 12. The holographic lens may be simultaneously exposed to the laser diode light and backward traveling light exiting the input facet of the fiber. The light exiting the input facet of the fiber may be launched backwards, into the far end of the fiber. The lens 70 may be developed into a holographic lens that automatically aligns the laser diode 20 and fiber 30 since they act as sources for writing the hologram. To enable enhanced hologram writing, a single mode fiber could be inserted into the ferrule during the writing step. The fiber could be removed and replaced with another fiber or stub which may subsequently be bonded to the ferrule. Examples of low cost refractive lenses that can be integrated into the lighting device 10 are disclosed in U.S. Pat. Nos. 7,505,650 and 8,616,023, the entire disclosures of which are hereby incorporated by reference.

Accordingly, the lighting device 10 advantageously couples light from a light source package, such as a TO can package, to a light diffusing fiber 30 using a single lens 70 to provide light illumination. The lighting device 10 may employ an existing TO can package without the need for a plurality of optical lenses which results in a significant size reduction and allows for a compact and economical to manufacture device. The lighting device 10 has a sufficiently small width and length such that it may be advantageously employed in any of a number of applications such as in a cell phone.

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. A lighting device comprising:
a light source package comprising a diode disposed in a first housing having a first opening, the diode emitting light at an emission point within the first housing;
a lens disposed on the first housing proximate the first opening and optically aligned with the emission point;
a second housing substantially enclosing the first housing and the lens, said second housing having a second opening; and
an optical fiber extending through the second opening in the second housing and having a terminal end optically aligned with the lens and diode, wherein the lens is disposed between the terminal end of the fiber and the diode and the terminal end of the fiber is within a distance of less than 2.5 millimeters from the emission point, and wherein the fiber emits light via a light diffusing fiber.

2. The lighting device of claim 1, wherein the fiber is the light diffusing fiber.

3. The lighting device of claim 1, wherein the fiber is a delivery fiber that is optically coupled to the light diffusing fiber.

4. The lighting device of claim 3 further comprising a ferrule extending into the second opening and connected to the second housing and having the fiber disposed in the ferrule.

5. The lighting device of claim 4, wherein the fiber is a delivery fiber.

6. The lighting device of claim 4, wherein the ferrule is hermetically sealed to the second housing.

7. The lighting device of claim 6 further comprising an adhesive disposed between the ferrule and the second housing.

8. The lighting device of claim 1, wherein the fiber is a multimode fiber.

9. The lighting device of claim 1, wherein the fiber comprises a core having a diameter greater than 20 microns.

10. The lighting device of claim 1, wherein the lens comprises a holographic lens.

11. The lighting device of claim 1, wherein the light source package is a TO can package comprising a laser diode.

12. The lighting device of claim 1, wherein the first housing comprises a metal can and the second housing comprising a thermally conductive material.

13. The lighting device of claim 1, wherein only a single optical lens is disposed between the terminal end of the fiber and the emission point of the diode.

14. The lighting device of claim 1, wherein the fiber is hermetically sealed to the second housing.

15. A method of manufacturing a lighting device comprising:
providing a light source package comprising a diode disposed in a first housing, wherein the diode emits light at an emission point within the first housing;
forming a first opening in the first housing;
disposing a lens within the first opening of the first housing;
encapsulating the first housing and lens within a second housing having a second opening therein;
disposing an optical fiber extending into the second opening in the second housing and having a terminal end optically aligned with the diode, wherein the lens is disposed between the terminal end of the fiber and the diode and the terminal end of the fiber is within a distance of less than 2.5 millimeters from the emission point, and wherein the fiber emits light to a light diffusing fiber; and
fixedly connecting the fiber relative to the second housing in an optically aligned position such that light is transmitted from the emission point to the light diffusing fiber.

16. The method of claim 15, wherein the fiber is a light diffusing fiber.

17. The method of claim 15, wherein the fiber is a delivery fiber that is optically coupled to the light diffusing fiber.

18. The method of claim 17 further comprising the step of coupling a ferrule to the housing such that the fiber extends through the second opening, wherein the delivery fiber extends through the ferrule.

19. The method of claim 15 further comprising the step of forming the lens as a holographic lens by creating a lens grating when the lens is disposed in the first opening of the first housing.

20. The method of claim 15, wherein the light source package is a TO can package comprising a laser diode.
